(19) United States
(12) Patent Application Publication
(10) Pub. No.: US 2014/0076790 A1
(43) Pub. Date: Mar. 20, 2014

(54) CENTRAL CORE ELEMENT FOR A SEPARATOR ASSEMBLY

(71) Applicants: Chen Wang, Shanghai (CN); Todd Alan Anderson, Niskayuna, NY (US); Hua Li, Shanghai (CN); Su Lu, Shanghai (CN)

(72) Inventors: Chen Wang, Shanghai (CN); Todd Alan Anderson, Niskayuna, NY (US); Hua Li, Shanghai (CN); Su Lu, Shanghai (CN)

(73) Assignee: General Electric Company, Schenectady, NY (US)

(21) Appl. No.: 14/122,907

(22) PCT Filed: May 31, 2012
(86) PCT No.: PCT/US2012/040065

§ 371 Date: Nov. 27, 2013

(30) Foreign Application Priority Data
Jun. 2, 2011 (CN) 201110148027.1

(51) Int. Cl. B01D 61/08

(52) U.S. Cl. CPC B01D 61/08
USPC 210/232; 29/890.14

(57) ABSTRACT

The present invention provides a central core element a reverse osmosis separator assembly useful in the purification of fluids. The central core element comprises an outer exhaust conduit defining an inner volume and a gap starting at a first end thereof the outer exhaust conduit and extending towards a second end of the outer exhaust conduit, and an inner porous exhaust conduit comprising a first section disposed within the inner volume defined by outer exhaust conduit and a second section configured to abut and seal the first end of the outer exhaust conduit. The outer exhaust conduit is configured to accommodate a first portion of a membrane stack assembly within the inner volume and a second portion of the membrane stack assembly disposed as a multilayer membrane assembly on an outer surface of the outer exhaust conduit. The gap is configured to accommodate a transition section of the membrane stack assembly linking the first portion of the membrane stack assembly with the second portion of the membrane stack assembly. The first inner porous exhaust conduit section is configured to be disposed within the first portion of the membrane stack assembly.

### BACKGROUND

This invention includes embodiments that generally relate to a central core element for separator assemblies. In various embodiments, the invention relates to central core elements for spiral flow separator assemblies. The invention also includes methods for making separator assemblies comprising the central core elements provided by the present invention.

Conventional separator assemblies typically comprise a folded multilayer membrane assembly disposed around a porous exhaust conduit. The folded multilayer membrane assembly comprises a feed carrier layer in fluid contact with the active-surface of a membrane layer having an active surface and a passive surface. The folded multilayer membrane assembly also comprises a permeate carrier layer in contact with the passive surface of the membrane layer and a porous exhaust conduit. The folded membrane layer structure ensures contact between the feed carrier layer and the membrane layer without bringing the feed carrier layer into contact with the permeate carrier layer or the porous exhaust conduit. During operation, a feed solution containing a solute is brought into contact with the feed carrier layer of the multilayer membrane assembly which transmits the feed solution to the active surface of the membrane layer which modifies and transmits a portion of the feed solution as a permeate to the permeate carrier layer. The feed solution also serves to disrupt solute accretion at the active surface of the membrane layer and transport excess solute out of the multilayer membrane assembly. The permeate passes via the permeate carrier layer into the porous exhaust conduit which collects the permeate. Separator assemblies comprising folded multilayer membrane assemblies have been used in various fluid purification processes, including reverse osmosis, ultrafiltration, and microfiltration processes.

Folded multilayer membrane assemblies may be manufactured by bringing the active surface of a membrane layer having an active surface and a passive surface into contact with both surfaces of a feed carrier layer, the membrane layer being folded to create a pocket-like structure which envelops the feed carrier layer. The passive surface of the membrane layer is brought into contact with one or more permeate carrier layers to produce a membrane stack assembly in which the folded membrane layer is disposed between the feed carrier layer and one or more permeate carrier layers. A plurality of such membrane stack assemblies, each in contact with at least one common permeate carrier layer, is then wound around a conventional porous exhaust conduit in contact with the common permeate carrier layer to provide the separator assembly comprising the multilayer membrane assembly and the porous exhaust conduit. The edges of the membrane stack assemblies are appropriately sealed to prevent direct contact of the feed solution with the permeate carrier layer. A serious weakness separator assemblies comprising a folded multilayer membrane assembly is that the folding of the membrane layer may result in loss of membrane function leading to uncontrolled contact between the feed solution and the permeate carrier layer.

Thus, there exists a need for further improvements in both the design and manufacture of separator assemblies comprising one or more multilayer membrane assemblies. Particularly in the realm of water purification for human consumption, there is a compelling need for more robust and reliable separator assemblies which are both efficient and cost effective.

### BRIEF DESCRIPTION

In one embodiment, the present invention provides a central core element a central core element a reverse osmosis separator assembly useful in the purification of fluids. The central core element comprises an outer exhaust conduit defining an inner volume and a gap starting at a first end thereof the outer exhaust conduit and extending towards a second end of the outer exhaust conduit, and an inner porous exhaust conduit comprising a first section disposed within the inner volume defined by outer exhaust conduit and a second section configured to abut and seal the first end of the outer exhaust conduit. The outer exhaust conduit is configured to accommodate a first portion of a membrane stack assembly within the inner volume and a second portion of the membrane stack assembly disposed as a multilayer membrane assembly on an outer surface of the outer exhaust conduit. The gap is configured to accommodate a transition section of the membrane stack assembly linking the first portion of the membrane stack assembly with the second portion of the membrane stack assembly. The first inner porous exhaust conduit section is configured to be disposed within the first portion of the membrane stack assembly.

These and other features, aspects, and advantages of the present invention may be understood more readily by reference to the following detailed description.

### BRIEF DESCRIPTION OF THE DRAWING FIGURES

The various features, aspects, and advantages of the present invention will become better understood when the following detailed description is read with reference to the accompanying drawings in which like characters may represent like parts throughout the drawings.

FIG. 1 illustrates the components of a conventional separator assembly and method of its assembly.

FIGS. 2A and 2B illustrate an outer exhaust conduit of a central core element in accordance with an embodiment of the present invention.

FIGS. 3A and 3B illustrate an inner porous exhaust conduit of a central core element in accordance with an embodiment of the present invention.

FIGS. 4A-4E illustrate a method of using a central core element provided by the present invention to make a separator assembly.

FIG. 5 illustrates a separator assembly comprising a central core element of the present invention.

### DETAILED DESCRIPTION

In the following specification and the claims, which follow, reference will be made to a number of terms, which shall be defined to have the following meanings.

The singular forms “a”, “an”, and “the” include plural referents unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about” and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

As noted, the present invention provides a central core element for a separator assembly, the central core element comprising an outer exhaust conduit defining an inner volume and a gap starting at a first end thereof the outer exhaust conduit and extending towards a second end of the outer exhaust conduit, and an inner porous exhaust conduit comprising a first section disposed within the inner volume defined by outer exhaust conduit and a second section configured to abut and seal the first end of the outer exhaust conduit, the outer exhaust conduit configured to accommodate a first portion of a membrane stack assembly within the inner volume and a second portion of the membrane stack assembly disposed as a multilayer membrane assembly on an outer surface of the outer exhaust conduit, the gap configured to accommodate a transition section of the membrane stack assembly linking the first portion of the membrane stack assembly with the second portion of the membrane stack assembly, and the first inner porous exhaust conduit section configured to be disposed within the first portion of the membrane stack assembly.

An exhaust conduit of central core element for a separator assembly comprising a membrane stack assembly is a permeate or concentrate exhaust conduit, which defines an exhaust channel for collecting a permeate or concentrate, and through which a permeate or concentrate flows and exits from the central core element. Either the outer exhaust conduit or the inner porous exhaust conduit may be a permeate exhaust conduit or a concentrate exhaust conduit depending on which layer or layers of the membrane stack assembly the exhaust conduit is in contact with. A layer is “in contact” with an exhaust conduit when the layer is configured to permit transfer of fluid from the layer into the conduit without passing through an intervening membrane layer. A permeate exhaust conduit is in contact with a permeate carrier layer surface (or in certain embodiments a membrane layer surface) in such a way that permeate may pass from the permeate carrier layer into the permeate exhaust conduit. A concentrate exhaust conduit is in contact with a feed carrier layer surface in such a way that concentrate may pass from the feed carrier layer into the concentrate exhaust conduit. Fluid passing from a permeate carrier layer into an exhaust conduit is at times herein referred to as “permeate” (or “the permeate”) and the exhaust conduit is referred to as the permeate exhaust conduit. Fluid passing from a feed carrier layer into an exhaust conduit is at times herein referred to as “concentrate” (or “the concentrate”, or simply “brine”) and the exhaust conduit is referred to as the concentrate exhaust conduit.

Each exhaust conduit is typically a tube running the length of the separator assembly, although other configurations may fall within the meaning of the term exhaust conduit. The tube may be a longitudinally extending structure with an arbitrary cross section. Suitable tubes, which may serve as the exhaust conduit of a central core element provided by the present invention include metal tubes, plastic tubes, ceramic tubes and the like. A porous exhaust conduit is typically a perforated or grooved tube, or a tube which is not perforated or grooved but is sufficiently porous to allow passage of fluid from either the permeate carrier layer or the feed carrier layer into the interior of the porous exhaust conduit. In one embodiment, the inner porous exhaust conduit may comprise a porous conduit section adapted for contact with the permeate carrier layer or the feed carrier layer and a nonporous conduit section not adapted for contact with the permeate carrier layer or the feed carrier layer. In one embodiment, at least one of the outer exhaust conduit and the inner porous exhaust conduit is a circular tube.

The central core elements provided by the present invention may be made by a variety of methods, for example by injection molding, blow molding, and molding techniques such as clam shell injection molding, over-molding and gas assisted molding, techniques well known to one of ordinary skill in the art. The central core elements provided by the present invention may be made of any suitable material, however, due to a combination of strength and low cost, thermoplastics such as polyethylene may be preferred.

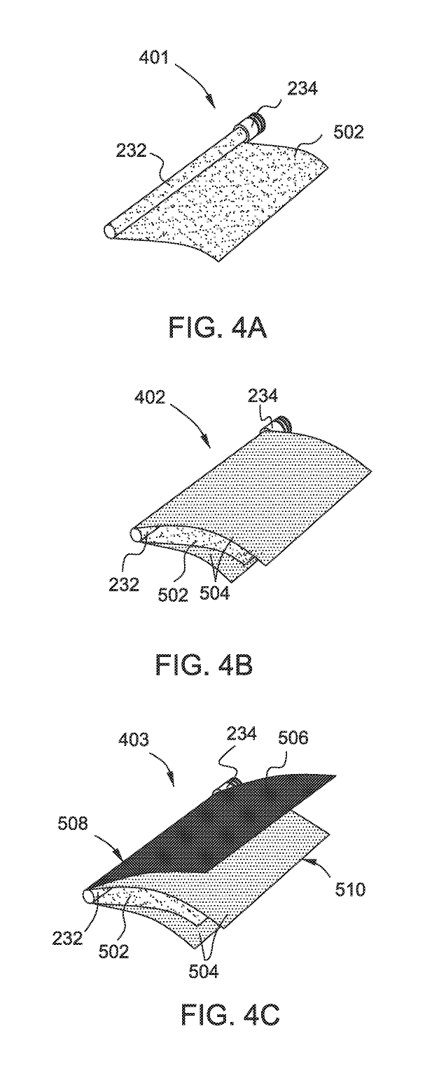

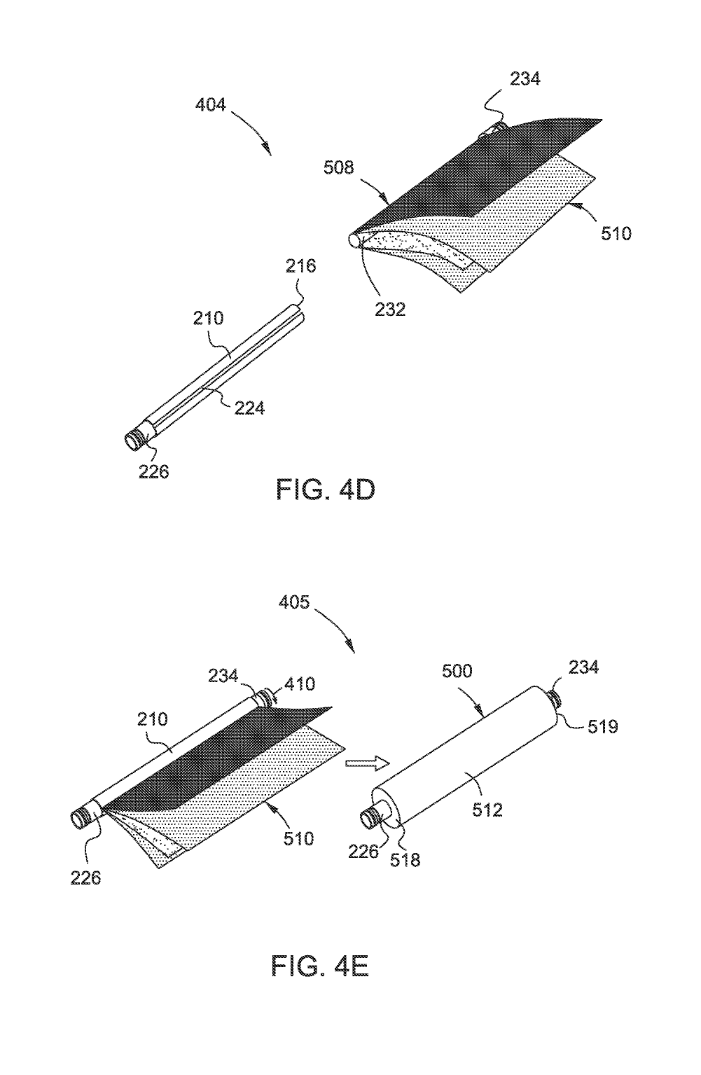

As used herein, the term “membrane stack assembly” refers to an assembly comprising at least one feed carrier layer, at least one permeate carrier layer and at least one membrane layer, and the term “multilayer membrane assembly” refers to a second portion of the membrane stack assembly disposed around the central core element. FIG. 4D disclosed herein illustrates first and second portions (508 and 510) of the membrane stack assembly. In the embodiment shown in FIG. 4E, the multilayer membrane assembly comprises the second portion 510 of the membrane stack assembly disposed around the outer exhaust conduit of the central core element. The multilayer membrane assembly comprises one feed carrier layer 506, one permeate carrier layers 502, and two membrane layers 504 (provided by two halves of a folded membrane layer) disposed around the central core element comprising outer exhaust conduit 210 and inner porous exhaust conduit 230.

Separator assemblies comprising a central core element provided by the present invention may be prepared by disposing a first portion 508 (FIG. 4D) of a membrane stack assembly around the first inner porous exhaust conduit section 232, inserting the first inner porous exhaust conduit section disposed within the first portion of the membrane stack assembly into the inner volume of the outer exhaust conduit 210 from the first end 216 of the outer exhaust conduit, while having a second portion 510 of the membrane stack assembly kept outside the outer exhaust conduit 210 and a transition section of the membrane stack assembly linking the first portion of the membrane stack assembly with the second portion of the membrane stack assembly inserted into the gap 224 defined by the outer exhaust conduit, and radially disposing the second portion 510 of the membrane stack assembly as a multilayer membrane assembly on an outer surface of the outer exhaust conduit 210.

Those skilled in the art will appreciate the close relationship, in certain instances, between the membrane stack assembly and the multilayer membrane assembly, and that the membrane stack assembly is the precursor of the multilayer membrane assembly. It is convenient to regard the membrane stack assembly as “unwound” and the multilayer membrane assembly as “wound”. It should be emphasized, however, that as defined herein a multilayer membrane assembly is not limited to the “wound” form of one or more membrane stack assemblies disposed around a central core element, as other means of disposing the second portion of the membrane stack assembly around the central core element may become available.

Both the membrane stack assembly and the multilayer membrane assembly comprise at least one feed carrier layer. Materials suitable for use as the feed carrier layer include flexible sheet-like materials through which a feed solution may flow. In certain embodiments, the feed carrier layer is configured such that flow of a feed solution through the feed carrier layer occurs along the axis of the separator assembly from points on a first surface of the separator assembly (the “feed surface”) where the feed carrier layer is in contact with the feed solution and terminating at a second surface of the separator assembly where a concentrate emerges (the “concentrate surface”) from the feed carrier layer. In certain embodiments, the feed carrier layer is configured such that a feed solution flows in a spiral path along the feed carrier layer to the concentrate exhaust conduit. The feed carrier layer may comprise structures which promote turbulent flow at the surface of the membrane layer in contact with the feed carrier layer as a means of preventing excessive solute build-up (accretion) at the membrane surface. In one embodiment, the feed carrier layer is comprised of a perforated plastic sheet. In another embodiment, the feed carrier layer is comprised of a perforated metal sheet. In yet another embodiment, the feed carrier layer comprises a porous composite material. In yet another embodiment, the feed carrier layer is a plastic fabric. In yet another embodiment, the feed carrier layer is a plastic screen. The feed carrier layer may be comprised of the same material as the permeate carrier layer or a material different from that used for the permeate carrier layer.

In certain embodiments, the membrane stack assembly and the multilayer membrane assembly of a separator assembly comprising a central core element provided by the present invention comprise a single permeate carrier layer. In certain other embodiments, the membrane stack assembly and the multilayer membrane assembly comprise at least two permeate carrier layers. Materials suitable for use as a permeate carrier layer include flexible sheet-like materials through which a permeate may flow. In various embodiments, the permeate carrier layer is configured such that during operation of a separator assembly comprising a central core element provided by the present invention, permeate flows in a spiral path along the permeate carrier layer to the permeate exhaust conduit. In one embodiment, the permeate carrier layer is comprised of a perforated plastic sheet. In another embodiment, the permeate carrier layer is comprised of a perforated metal sheet. In yet another embodiment, the permeate carrier layer comprises a porous composite material. In yet another embodiment, the permeate carrier layer is a plastic fabric. In yet another embodiment, the permeate carrier layer is a plastic screen. In separator assemblies comprising multiple permeate carrier layers, the permeate carrier layers may be made of the same or different materials, for example one permeate carrier layer may be a plastic fabric while the another permeate carrier layer is a natural material such as wool fabric. In addition a single permeate carrier layer may comprise different materials at different locations along the permeate flow path through the permeate carrier layer. In one embodiment, for example, the present invention provides a central core element useful in a separator assembly comprising a permeate carrier layer, a portion of which permeate carrier layer is a polyethylene fabric, and another portion of which permeate carrier layer is polypropylene fabric.

In certain embodiments, the central core element provided by the present invention may be used in a separator assembly comprising a single membrane layer. In certain other embodiments, the central core element provided by the present invention may be used in a separator assembly comprising at least two membrane layers. Membranes and materials suitable for use as membrane layers are well-known in the art. U.S. Pat. No. 4,277,344, for example, discloses a semipermeable membrane prepared from the reaction of an aromatic polyamine with a polyacyl halide which has been found to be effective in reverse osmosis systems directed at rejecting sodium, magnesium and calcium cations, and chlorine, sulfate and carbonate anions. U.S. Pat. No. 4,277,344, for example, discloses a membrane prepared from the reaction of an aromatic polyacyl halide with a bifunctional aromatic amine to afford a polymeric material, which has been found useful in the preparation of membrane layers effective in reverse osmosis systems directed at rejecting certain salts, such as nitrates. A host of technical references describing the preparation of various membranes and materials suitable for use as the membrane layer in separator assemblies comprising the central core element provided by the present invention are known to those of ordinary skill in the art. In addition, membranes suitable for use as the membrane layer in various embodiments of separator assemblies comprising the central core elements of the present invention are well known and widely available articles of commerce.

In one embodiment, at least one of the membrane layers comprises a functionalized surface and an unfunctionalized surface. In one embodiment, the functionalized surface of the membrane layer represents an active surface of the membrane and the unfunctionalized surface of the membrane layer represents a passive surface of the membrane. In an alternate embodiment, the functionalized surface of the membrane layer represents a passive surface of the membrane and the unfunctionalized surface of the membrane layer represents an active surface of the membrane. In various embodiments, the active surface of the membrane layer is typically in contact with the feed carrier layer and serves to prevent or retard the transmission of one or more solutes present in the feed solution across the membrane to the permeate carrier layer.

As used herein the phrase “not in contact” means not in “direct contact”. For example, two layers of a membrane stack assembly, or a multilayer membrane assembly, are not in contact when there is an intervening layer between them despite the fact that the two layers are in fluid communication, since in general a fluid may pass from one layer to the other via the intervening layer. As used herein the phrase “in contact” means in “direct contact”. For example, adjacent layers in the membrane stack assembly, or the multilayer membrane assembly, are said to be “in contact”. Similarly a layer touching the surface of an exhaust conduit , as for example when a layer is wound around the exhaust conduit, is said to be “in contact” with the exhaust conduit provided that fluid may pass from the layer into the exhaust conduit. As a further illustration, a permeate carrier layer is said to be in contact with a permeate exhaust conduit when the permeate carrier layer is in direct contact with the permeate exhaust conduit, as for example when the permeate carrier layer is wound around the permeate exhaust conduit with no intervening layers between the surface of the permeate exhaust conduit and the permeate carrier layer. Similarly, a feed carrier layer is said to be not in contact with a permeate exhaust conduit, as when, for example, a permeate carrier layer is in direct contact with the permeate exhaust conduit and the permeate carrier layer is separated from the feed carrier layer by a membrane layer. In general, a feed carrier layer has no point of contact with a permeate exhaust conduit.

In one embodiment, the central core element provided by the present invention may be employed in a separator assembly in which a multilayer membrane assembly is radially disposed around the central core element. As used herein the phrase “radially disposed” means that a second portion of the membrane stack assembly comprising at least one feed carrier layer, at least one membrane layers, and at least one permeate carrier layers is wound around the outer exhaust conduit of a central core element comprising an outer exhaust conduit and an inner porous exhaust conduit in a manner that limits the creation of folds or creases in the membrane layer.

In one embodiment, the central core element provided by the present invention may be used to prepare a salt separator assembly for separating salt from water, for example, seawater or brackish water. Typically the separator assembly is contained within a cylindrical housing which permits initial contact between the feed solution and the feed carrier layer only at one surface of the separator assembly, at times referred to herein as the “feed surface”. This is typically accomplished by securing the separator assembly within the cylindrical housing with, for example one or more gaskets, which prevent contact of the feed solution with surfaces of the separator assembly other than the feed surface. To illustrate this concept, the separator assembly can be thought of as a cylinder having a first surface and a second surface each having a surface area of πr², wherein “r” is the radius of the cylinder defined by the separator assembly, and a third surface having a surface area of 2πrh wherein “h” is the length of the cylinder. The separator assembly can by various means be made to fit snugly into a cylindrical housing such that a feed solution entering the cylindrical housing from one end encounters only the “feed surface” (one of the first, second and third surfaces) of the separator assembly and does not contact surfaces of the separator assembly other than the feed surface without passing through the separator assembly.

In one embodiment, the feed solution enters the separator assembly at points on the first surface of the separator assembly where the feed carrier layer is in contact with the feed solution, the edges of the membrane stack assembly being sealed to prevent contact and transmission of the feed solution from the first surface of separator assembly by the permeate carrier layer. The feed solution enters the separator assembly at the first surface of the separator assembly and travels along the length (axis) of the separator assembly during which passage, the feed solution is modified by its contact with the membrane layer through which a portion of the feed solution (“permeate” or “the permeate”) passes and contacts the permeate carrier layer. The feed solution is said to flow axially through the separator assembly until it emerges as “concentrate” (also referred to at times as brine) at the second surface of the separator assembly, sometimes referred to herein as the “concentrate surface”. This type of flow of feed solution through the separator assembly is at times herein referred to as “cross-flow”, and the term “cross-flow” may be used interchangeably with the term “axial flow” when referring to the flow of feed solution. In an alternate embodiment, feed solution is introduced into the separator assembly through the third surface, in which case the third surface is referred to as the “feed surface”. Typically, when a feed solution is introduced into the separator assembly through this “third surface” flow of feed solution through the feed carrier layer and flow of permeate through the permeate carrier layer occurs along a spiral path inward toward a concentrate exhaust conduit and a permeate exhaust conduit respectively. Those skilled in the art will appreciate that as a feed solution, for example seawater, travels from an initial point of contact between the feed solution with the feed carrier layer on the feed surface of the separator assembly toward a concentrate surface or a concentrate exhaust conduit, the concentration of salt present in the fluid in the feed carrier layer is increased through the action of the salt-rejecting membrane layer in contact with the feed solution passing through the feed carrier layer, and that the concentrate reaching the concentrate surface or the concentrate exhaust conduit will be characterized by a higher concentration of salt than the seawater used as the feed solution.

The roles and function of permeate exhaust conduits and permeate carrier layers may be illustrated using the salt separator assembly example above. Thus, in one embodiment, the separator assembly may be used as a salt separator assembly for separating salt from water. The feed solution, for example seawater, is contacted with the feed surface of a cylindrical separator assembly contained within a pressurizable housing. The separator assembly is configured such that a permeate carrier layer cannot transmit feed solution from the feed surface to a permeate exhaust conduit. As the feed solution passes through the feed carrier layer it contacts the salt-rejecting membrane layer which modifies and transmits a fluid comprising one or more components of the feed solution to the permeate carrier layer. This fluid transmitted by the salt-rejecting membrane layer, called permeate (or “the permeate”), passes along the permeate carrier layer until it reaches that portion of the permeate carrier layer in contact with the permeate exhaust conduit, where the permeate is transmitted from the permeate carrier layer into the interior of the permeate exhaust conduit. Flow of permeate through the permeate carrier layer is referred to as “spiral flow” since the permeate tends to follow a spiral path defined by the permeate carrier layer toward the permeate exhaust conduit. Those skilled in the art will appreciate that as a feed solution, is modified and transmitted by the salt-rejecting membrane layer into the permeate carrier layer, the concentration of salt in the permeate is reduced relative to the feed solution due to the salt-rejecting action of the membrane layer.

As described above, either the outer exhaust conduit or the inner exhaust conduit of the central core element provided by the present invention may be a permeate exhaust conduit or a concentrate exhaust conduit depending on which layer or layers of the membrane stack assembly the exhaust conduit is in contact with. In one embodiment, both the outer exhaust conduit and the inner porous exhaust conduit are in contact with the permeate carrier layer but not in contact with the feed carrier layer and therefore serve as the permeate exhaust conduits. The feed solution enters the separator assembly at the first surface of the separator assembly and flow axially through the separator assembly until it emerges as “concentrate” at the second surface of the separator assembly, while the permeate flows through the permeate carrier layer along a spiral path defined by the permeate carrier layer toward the outer exhaust conduit and the inner porous exhaust conduit. In another embodiment, the outer exhaust conduit is in contact with the feed carrier layer and serves as the concentrate exhaust conduit, whereas the inner porous exhaust conduit is in contact with the permeate carrier layer and serves as the permeate exhaust conduit. The feed solution enters the separator assembly from the third surface of the separator assembly which is comprised exclusively of the feed carrier layer, and flow of feed solution through the feed carrier layer and flow of permeate through the permeate carrier layer occurs along a spiral path inward toward the outer exhaust conduit and the inner porous exhaust conduit respectively. In yet another embodiment, the outer exhaust conduit is in contact with the permeate carrier layer and serves as the permeate exhaust conduit, and the inner porous exhaust conduit is in contact with the feed carrier layer and serves as the concentrate exhaust conduit. The feed solution enters the separator assembly from the third surface of the separator assembly which is comprised exclusively of the feed carrier layer, and flow of feed solution through the feed carrier layer and flow of permeate through the permeate carrier layer occurs along a spiral path inward toward the inner porous exhaust conduit and the outer exhaust conduit respectively.

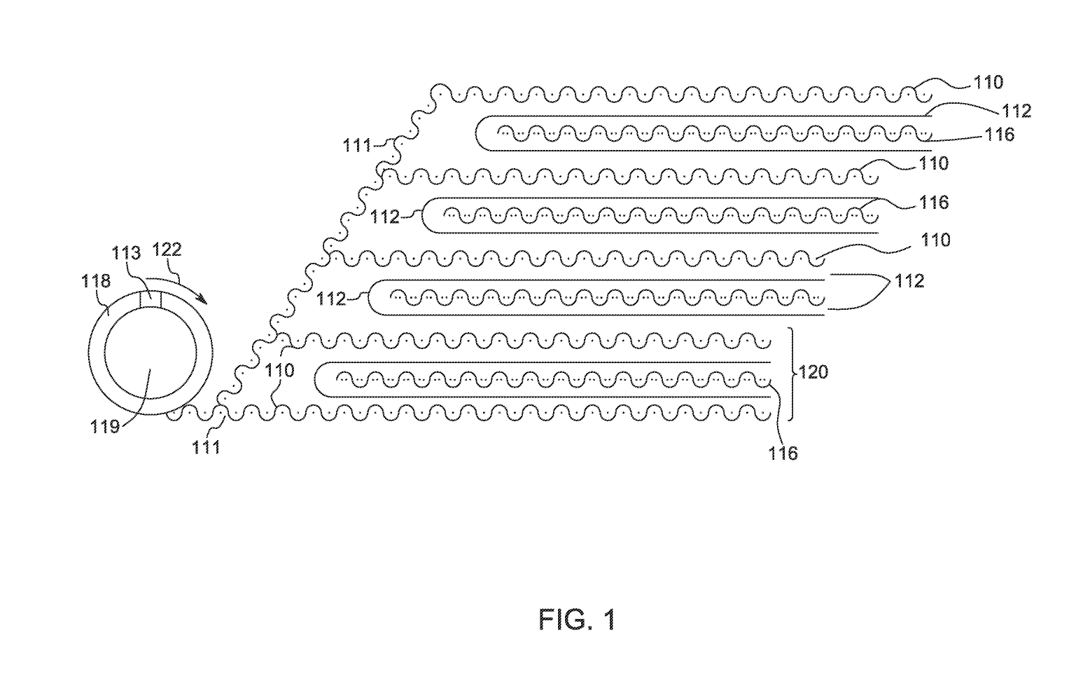

Referring to FIG. 1, the figure represents the components of and method of making a conventional separator assembly. A conventional membrane stack assembly 120 comprises a folded membrane layer 112 wherein a feed carrier layer 116 is sandwiched between the two halves of the folded membrane layer 112. The folded membrane layer 112 is disposed such that an active side (not shown in figure) of the folded membrane layer is in contact with the feed carrier layer 116. An active side of the membrane layer 112 is at times herein referred to as “the active surface” of the membrane layer. The folded membrane layer 112 is enveloped by permeate carrier layers 110 such that the passive side (not shown in figure) of the membrane layer 112 is in contact with the permeate carrier layers 110. A passive side of the membrane layer 112 is at times herein referred to as “the passive surface” of the membrane layer. Typically, an adhesive sealant (not shown) is used to isolate the feed carrier layer from the permeate carrier layer and prevent direct contact between a feed solution (not shown) and the permeate carrier layer. A plurality of membrane stack assemblies 120 wherein each of the permeate carrier layers 110 is connected to a common permeate carrier layer 111 in contact with a conventional permeate exhaust conduit 118 is wound around the permeate exhaust conduit 118, for example by rotating the permeate exhaust conduit 118 in direction 122, and the resultant wound structure is appropriately sealed to provide a conventional separator assembly. The conventional permeate exhaust conduit 118 comprises openings 113 to permit fluid communication between the permeate exhaust conduit channel 119 and the common permeate carrier layer 111. As the membrane stack assemblies are wound around the permeate exhaust conduit 118, the reflex angle defined by the folded membrane layer 112 approaches 360 degrees.

In general, the greater the extent to which a membrane layer is deformed by folding or creasing, the greater the likelihood of damage to the active surface of the membrane, loss of membrane function, and membrane integrity.

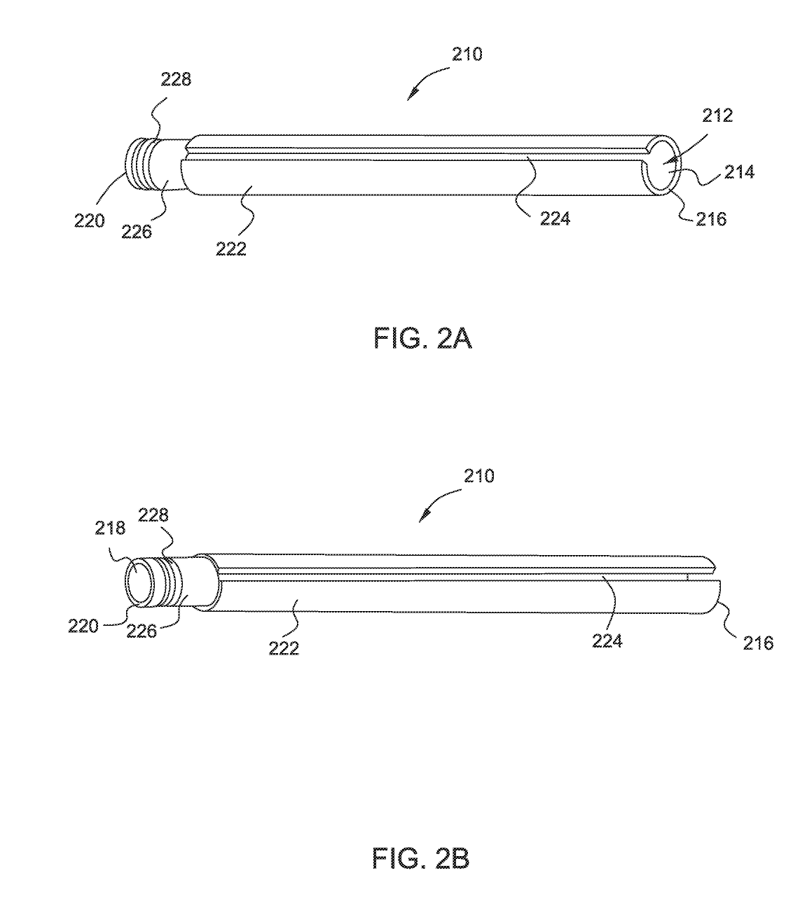

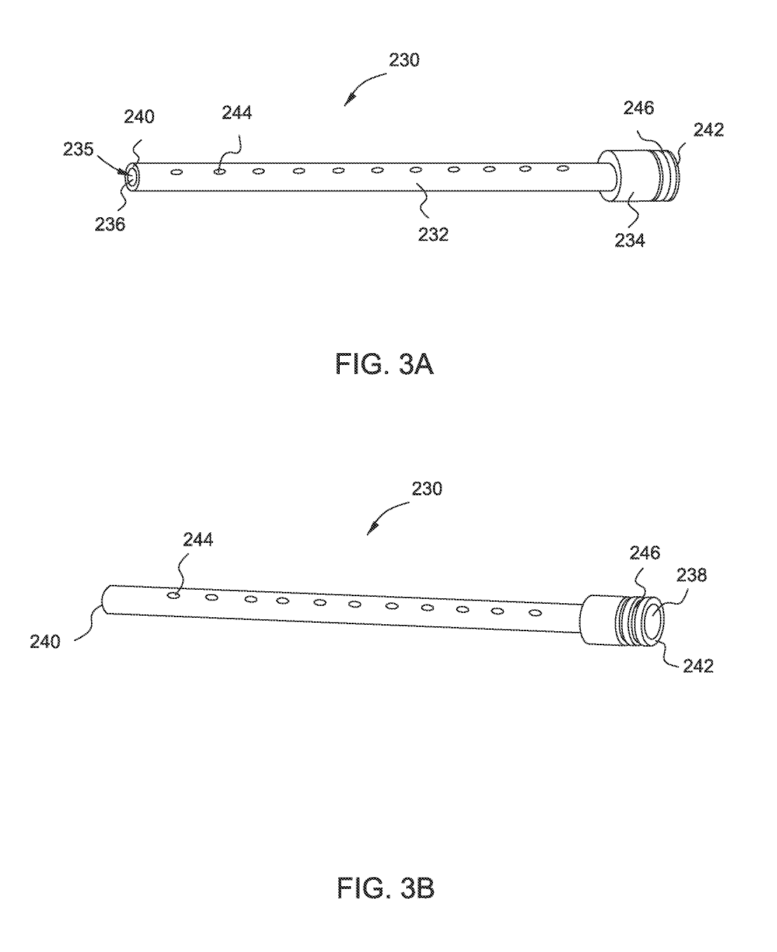

Referring to FIGS. 2A-3B, a central core element for a reverse osmosis separator assembly, which comprises an outer exhaust conduit 210 and an inner porous exhaust conduit 230, is provided.

Referring to FIGS. 2A and 2B, the outer exhaust conduit 210 comprises a first section 222 configured to contact with a membrane stack assembly and a second section 226 configured to not contact with the membrane stack assembly. The first section 222 starts at a first end 216 of the outer exhaust conduit, and extends towards a second end 220 of the outer exhaust conduit, and in one embodiment, ends at a point near the second end 220 of the outer exhaust conduit. The second section 226 starts at the second end 220 of the outer exhaust conduit, and extends towards the first end 216 of the outer exhaust conduit, and in one embodiment, ends at the point where the first section 222 ends. The outer exhaust conduit 210 defines an inner volume 212, which provides a first opening 214 at the first end 216 and a second opening 218 at the second end 220, and a gap 224, which allows fluid communication between an outer surface of the outer exhaust conduit and the inner volume 212 of the outer exhaust conduit. The gap 224 starts at the first end 216 and extends towards the second end 220. In one embodiment, the gap 224 extends along the whole length of the first section 222, i.e., starts at the first end 216 and ends at the point where the first section 222 ends. The second outer exhaust conduit section 226 defines one or more grooves 228 adapted to secure an O-ring. The outer exhaust conduit 210 may be or may not be porous at its portions other than the gap 228.

Referring to FIGS. 3A and 3B, the inner porous exhaust conduit 230 comprises a first section 232 configured to be disposed within the inner volume 212 defined by outer exhaust conduit 210, and a second section 234 configured to abut and seal the first end 216 of the outer exhaust conduit 210. The inner porous exhaust conduit 230 defines an interior exhaust channel 235, which provides openings 236 and 238 at opposite ends 240 and 242 of the inner porous exhaust conduit 230, respectively. The first inner porous exhaust conduit section 232 is configured to contact with a membrane stack assembly and defines a plurality of holes 244, which allow fluid communication between an outer surface of the first inner porous exhaust conduit section 232 and the interior exhaust channel 235 of the inner porous exhaust conduit. The second inner porous exhaust conduit section 234 is configured to not contact with the membrane stack assembly and defines one or more grooves 246 adapted to secure an O-ring.

Referring to FIGS. 4A-4E, the figures represent a method of using the central core element for making a reverse osmosis separator assembly. Referring to FIG. 4A, in a first method step 401, a first intermediate assembly is formed by wrapping a permeate carrier layer 502 on an outer surface of the first inner porous exhaust conduit section 232. In the first method step 401, the permeate carrier layer 502 may be wrapped around the first inner porous exhaust conduit section 232 one or more times, such that the permeate carrier layer 502 is in contact with the first inner porous exhaust conduit section 232, but layers subsequently disposed around the first inner porous exhaust conduit section, such as a membrane layer placed in contact with the first intermediate assembly of method step 401, is not in contact with the first inner porous exhaust conduit section 232. In one embodiment, the whole length of the first inner porous exhaust conduit section 232 is wrapped with the permeate carrier layer 502. That is to say, essentially the whole length of the first inner porous exhaust conduit section 232 is adapted for contact with the permeate carrier layer 502.

Referring to FIG. 4B, in a second method step 402, a second intermediate assembly is prepared. A membrane layer 504 having an active surface (not shown) and a passive surface (not shown) is folded on the first intermediate assembly of method step 401 such that the passive surface (not shown) of the membrane layer 504 is in contact with the permeate carrier layer 502. The membrane layer 504 is folded in half along the first inner porous exhaust conduit section 232 that is wrapped with the permeate carrier layer 502, providing two free halves of membrane layers for sandwiching the free portion of the permeate carrier layer 502. As the membrane layer 504 is folded around the first inner porous exhaust conduit section 232, the reflex angle defined by the folded membrane layer 504 will not approaches 360 degrees.

Referring to FIG. 4C, in a third method step 403, a third intermediate assembly is formed. A feed carrier layer 506 is applied to the second intermediate assembly shown in method step 402 such that the feed carrier layer 506 is in contact with the active surface (not shown) of membrane layer 504, and is coextensive with one half of the folded membrane layer 504. The third intermediate assembly depicted in method step 403 shows the first inner porous exhaust conduit section 232 is disposed within a first portion 508 of the membrane stack assembly comprising the permeate carrier layer 502, membrane layer 504 and feed carrier layer 506, and a second portion 510 of the membrane stack assembly extends to a side of the first inner porous exhaust conduit section 232.

Referring to FIG. 4D, in a fourth method step 404, a fourth intermediate assembly is formed. The outer exhaust conduit 210, which defines an inner volume and a gap 224 starting at a first end of the outer exhaust conduit and extending towards a second end of the outer exhaust conduit, is provided and disposed in a manner that, the first inner porous exhaust conduit section 232 together with the first portion 508 of the membrane stack assembly which is disposed around the first inner porous exhaust conduit section can be inserted into the inner volume of the outer exhaust conduit 210 from the first end 216 of the outer exhaust conduit.

Referring to FIG. 4E, both a fifth intermediate assembly and a substantially completed separator assembly 500 are shown. The fifth intermediate assembly is formed from the fourth intermediate assembly, by inserting the first inner porous exhaust conduit section 232 together with the first portion 508 of the membrane stack assembly that is disposed around the first inner porous exhaust conduit section into the inner volume of the outer exhaust conduit 210 from the first end 216 of the outer exhaust conduit, until the second inner porous exhaust conduit section 234 abuts the first end 216 of the outer exhaust conduit 210, while having the second portion 510 of the membrane stack assembly kept outside the outer exhaust conduit 210 and a transition section of the membrane stack assembly linking the first portion 508 of the membrane stack assembly with the second portion 510 of the membrane stack assembly inserted into the gap 224 defined by the outer exhaust conduit 210.

The free portions 510 of the fifth intermediate assembly outside of the outer exhaust conduit 210 (also referred to as the “second portion” of the membrane stack assembly) are wound around the outer exhaust conduit 210 by rotating the central core element in direction 410 thereby. A separator assembly 500 comprising a central core element provided by the present invention is obtained by completely winding the second portion 510 of the membrane stack assembly around the outer exhaust conduit 210 and securing the ends of the membrane stack assembly. The second portion 510 of membrane stack assembly which is radially disposed on an outer surface of the outer exhaust conduit 210 becomes the multilayer membrane assembly 512 of the completed separator assembly 500, and provides a first surface 518, a second surface 519 and a third surface 520 of the separator assembly 500. In one embodiment, the first and second surfaces 518 and 519 are cured by adhesive sealant to prevent contact of the feed solution with surfaces of the separator assembly other than the third surface, and also to isolate the feed carrier layer from the permeate carrier layer and prevent direct contact between a feed solution and the permeate carrier layer. The second outer exhaust conduit section 226 and the second inner porous exhaust conduit section 234 provide two opposite end portions of the central core element of the separator assembly 500, protruding from the first and second surfaces 518 and 519 of the separator assembly 500, respectively.

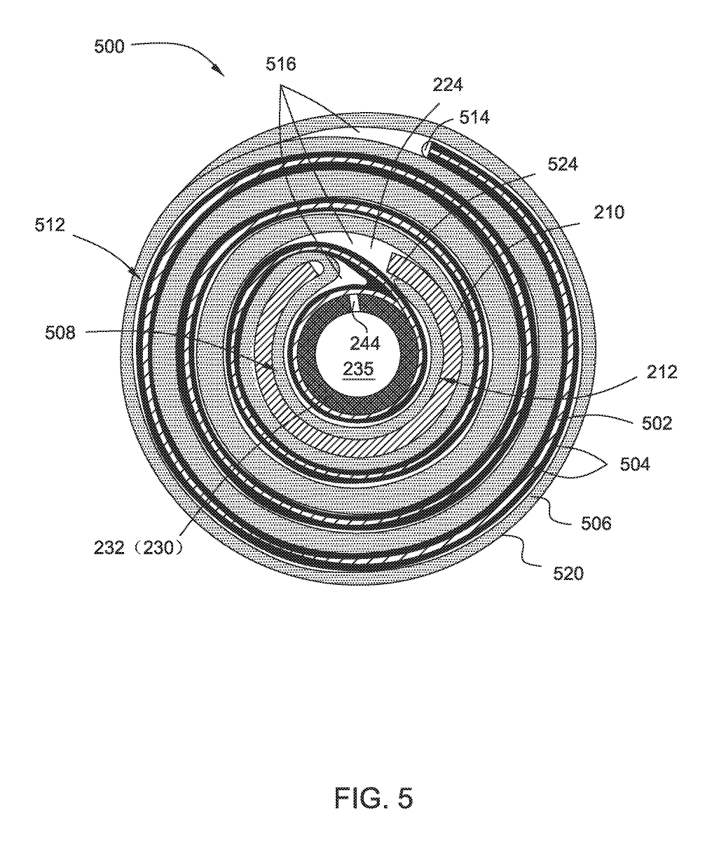

Referring to FIG. 5, the figure represents a cross-section view at midpoint of the separator assembly 500. The first portion 508 of the membrane stack assembly and the first inner porous exhaust conduit section 232 disposed within the first portion 508 is disposed within the inner volume 212 defined by outer exhaust conduit 210. The second portion 510 (FIG. 4E) of the membrane stack assembly forms a multilayer membrane assembly 512 disposed around the central core element. The transition section of the membrane stack assembly linking the first portion 508 of the membrane stack assembly with the second portion 510 of the membrane stack assembly is accommodated in the gap 224 defined by the outer exhaust conduit 210. The “third surface” 520 of the separator assembly 500 illustrated in FIG. 5 is comprised exclusively of the feed carrier layer 506 which envelops the underlying wound structure. The inner porous exhaust conduit 230 and the outer exhaust conduit 210 are arranged substantially coaxially with respect to each other.

The ends of membrane stack assembly are secured with a sealing portion 514. The sealing portion 514 is a transverse line of sealant (typically a curable glue) which seals the outermost permeate carrier layer 502 to the two adjacent membrane layers 504, said transverse line running the length of the separator assembly 500. Typically the sealant is applied to the passive surface of the membrane layer 504 which when contacted with the adjacent permeate carrier layer, the sealant penetrates and seals the edge of permeate carrier layer. The sealant does not typically penetrate through the active surface of the membrane layer and thus does not come into contact with either the active surface (not shown) of the membrane layer 504 or the feed carrier layer 506. A variety of adhesive sealants, such as glues and/or double-sided tapes may be used to secure the ends of the multilayer membrane assembly to one another, the permeate carrier layer and feed carrier layer to the permeate exhaust conduit and concentrate exhaust conduit, and the end feed carrier layer to itself on the outer surface of the separator assembly.

Also featured in FIG. 5 are gaps 516 between the outer surface of the separator assembly 500 and outermost layer of the multilayer membrane assembly, and between the portions of the exhaust conduits and the multilayer membrane assembly. It should be noted that the gaps illustrated in FIG. 5 are not present at all in various embodiments of the separator assemblies comprising the central core element provided by the present invention, and further that the size of gaps 516 shown in FIG. 5 has been exaggerated for the purposes of this discussion. Any gaps present within a separator assembly may be eliminated by filling the gap with gap sealant. Gap sealants include curable sealants, adhesive sealants, and the like.

FIG. 5 shows clearly that the permeate carrier layer 502 is in contact with the first inner porous conduit section 232 but not in contact with the outer exhaust conduit 210, and the feed carrier layer 506 is in contact with the outer exhaust conduit 210 but not in contact with either of the first inner porous conduit section 232 or the permeate carrier layer 502. Therefore, in the illustrated embodiment, the inner porous exhaust conduit 230 serves as the permeate exhaust conduit and the outer exhaust conduit 210 serves as the concentrate exhaust conduit. Feed solution fed from the third surface 520 is brought into the feed carrier layer 506. A portion of the feed solution as permeate is transmitted to the permeate carrier layer 502 through the membrane layer 504, passes through the permeate carrier layer 502 in a spiral direction defined by the wound permeate carrier layer, and enters the interior exhaust channel 235 of the inner porous exhaust conduit 230 through holes 244. The rest of the feed solution which remains within the feed carrier layer 506, passes through the feed carrier layer 506 in a spiral direction defined by the wound feed carrier layer and becomes progressively more concentrated as it does so, and finally, as concentrate, enters into an exhaust channel 524 defined within the outer exhaust conduit 210 and between the outer exhaust conduit 210 and the inner porous exhaust channel 230.

Referring to FIG. 5, in conjunction with FIGS. 2A-4E, in one embodiment, the opening 236 at the end 240 of the inner porous exhaust conduit 230 is sealed. In assembly, the second inner porous exhaust conduit section 234 abuts and seals the first end 216 and the first opening 214 of the outer exhaust conduit 210. Permeate in the interior exhaust channel 235 of the inner porous exhaust conduit 230 exits from the opening 238 at the second inner porous exhaust conduit section 234, and concentrate in the exhaust channel 524 defined between the outer exhaust conduit 210 and the inner porous exhaust channel 230 exits from the opening 218 at the second outer exhaust conduit section 226. Therefore, permeate and concentrate exit from two opposite ends of the central core element, respectively.

As will become apparent to those of ordinary skill in the art after reading this disclosure, the present invention offers significant advantages in terms of ease and cost of manufacture of separator assemblies generally.

The foregoing examples are merely illustrative, serving to illustrate only some of the features of the invention. The appended claims are intended to claim the invention as broadly as it has been conceived and the examples herein presented are illustrative of selected embodiments from a manifold of all possible embodiments. Accordingly, it is Applicants' intention that the appended claims are not to be limited by the choice of examples utilized to illustrate features of the present invention. As used in the claims, the word “comprises” and its grammatical variants logically also subtend and include phrases of varying and differing extent such as for example, but not limited thereto, “consisting essentially of” and “consisting of.” Where necessary, ranges have been supplied, those ranges are inclusive of all sub-ranges there between. It is to be expected that variations in these ranges will suggest themselves to a practitioner having ordinary skill in the art and where not already dedicated to the public, those variations should where possible be construed to be covered by the appended claims. It is also anticipated that advances in science and technology will make equivalents and substitutions possible that are not now contemplated by reason of the imprecision of language and these variations should also be construed where possible to be covered by the appended claims.

What is claimed is:

1. A central core element for a reverse osmosis separator assembly, said central core element comprising:
an outer exhaust conduit defining an inner volume and a gap starting at a first end of the outer exhaust conduit and extending towards a second end of the outer exhaust conduit; and
an inner porous exhaust conduit comprising a first inner porous exhaust conduit section disposed within the inner volume defined by the outer exhaust conduit, and a second inner porous exhaust conduit section configured to abut and seal the first end of the outer exhaust conduit,
wherein said outer exhaust conduit is configured to accommodate a first portion of a membrane stack assembly within said inner volume and a second portion of the membrane stack assembly disposed as a multilayer membrane assembly on an outer surface of the outer exhaust conduit, and
wherein said gap is configured to accommodate a transition section of the membrane stack assembly linking the first portion of the membrane stack assembly with the second portion of the membrane stack assembly, and wherein said first inner porous exhaust conduit section is configured to be disposed within the first portion of the membrane stack assembly.

2. The central core element according to claim 1, wherein the inner porous exhaust conduit is blocked at one end at the first inner porous exhaust conduit section.

3. The central core element according to claim 1, wherein the inner porous exhaust conduit defines therein an exhaust channel which provides an outlet at the second inner porous exhaust conduit section, and the outer exhaust conduit and the inner porous exhaust conduit define an annular cylindrical exhaust channel therebetween which provides an outlet at the second end of the outer exhaust conduit.

4. The central core element according to claim 1, wherein the inner porous exhaust conduit and the outer exhaust conduit are arranged substantially coaxially with respect to each other.

5. The central core element according to claim 1, wherein at least one of the inner porous exhaust conduit and the outer exhaust conduit is a circular tube.

6. The central core element according to claim 1, wherein the inner porous exhaust conduit and the outer exhaust conduit have different shapes.

7. The central core element according to claim 1, wherein the inner porous exhaust conduit and the outer exhaust conduit are circular tubes arranged substantially coaxially with respect to each other.

8. The central core element according to claim 1, wherein at least one of the second inner porous exhaust conduit section and an outer exhaust conduit section adjacent to the second end of the outer exhaust conduit comprises one or more grooves adapted to secure an O-ring.

9. A reverse osmosis separator assembly comprising:
a central core element comprising:
an outer exhaust conduit defining an inner volume and a gap starting at a first end of the outer exhaust conduit and extending towards a second end of the outer exhaust conduit; and
an inner porous exhaust conduit comprising a first inner porous exhaust conduit section disposed within the inner volume defined by the outer exhaust conduit, and a second inner porous exhaust conduit section configured to abut and seal the first end of the outer exhaust conduit,
wherein said outer exhaust conduit is configured to accommodate a first portion of a membrane stack assembly within said inner volume and a second portion of the membrane stack assembly disposed as a multilayer membrane assembly on an outer surface of the outer exhaust conduit, and wherein said gap is configured to accommodate a transition section of the membrane stack assembly linking the first portion of the membrane stack assembly with the second portion of the membrane stack assembly, and wherein said first inner porous exhaust conduit section is configured to be disposed within the first portion of the membrane stack assembly.

10. A method of making a reverse osmosis separator assembly comprising a central core element comprising an outer exhaust conduit defining an inner volume and a gap starting at a first end of the outer exhaust conduit and extending towards a second end of the outer exhaust conduit, and an inner porous exhaust conduit comprising a first inner porous exhaust conduit section disposed within the inner volume defined by the outer exhaust conduit, and a second inner porous exhaust conduit section configured to abut and seal the first end of the outer exhaust conduit, the method comprising:
disposing a first portion of a membrane stack assembly around the first inner porous exhaust conduit section;
inserting the first inner porous exhaust conduit section disposed within the first portion of the membrane stack assembly into the inner volume of the outer exhaust conduit from the first end of the outer exhaust conduit, while having a second portion of the membrane stack assembly kept outside the outer exhaust conduit and a transition section of the membrane stack assembly linking the first portion of the membrane stack assembly with the second portion of the membrane stack assembly inserted into the gap defined by the outer exhaust conduit; and
radially disposing the second portion of the membrane stack assembly as a multilayer membrane assembly on an outer surface of the outer exhaust conduit.
